(19) United States
(12) Patent Application Publication
(10) Pub. No.: US 2017/0246777 A1
(43) Pub. Date: Aug. 31, 2017

(54) MANUFACTURING STEPS FOR HAND TOOL

(71) Applicants: YI-FU CHEN, TAICHUNG CITY (TW); YAO-LIN CHO, TAICHUNG CITY (TW); ZI-YAN HUANG, TAICHUNG CITY (TW)

(72) Inventors: YI-FU CHEN, TAICHUNG CITY (TW); YAO-LIN CHO, TAICHUNG CITY (TW); ZI-YAN HUANG, TAICHUNG CITY (TW)

(21) Appl. No.: 15/597,263

(22) Filed: May 17, 2017

Related U.S. Application Data
(63) Continuation of application No. 14/666,256, filed on Mar. 23, 2015.

(51) Int. Cl. B29C 45/14; C25D 13/12; B25G 1/10

(52) U.S. Cl. CPC B29C 45/14; B25G 1/105; C25D 13/12; B29L 2031/283

(57) ABSTRACT

Manufacturing steps for manufacturing a hand tool include a step of preparing a base part which has a handle end and a head end; a step of molding: placing the base part in a molding device and coating plastic to the whole base part by way of plastic injection molding to form the base part into a semi-product which has a handle portion and a head portion, an installation hole defined through the head portion; a step of coating: electro-coating a material to outer surface of the plastic of the semi-product, and a step of assembly: assembling a ratchet driving unit in the installation hole by using fixing members so as to obtain a final product.

The present invention is a Continuation-In-Part application of applicant's former application of application No. 14/666,256, filed on Mar. 23, 2015, currently pending.

### BACKGROUND OF THE INVENTION

1. Fields of the Invention

2. Descriptions of Related Art

The conventional hand tools comprise a driving head and a handle which extends from the driving head. In order to have a strong strength so as to be durable even being operated roughly, the hand tools usually made by steel. The steel is expensive than other material and usually are treated by the following steps which are straightening, cutting, heat treatment, pressing and forging. The steps are complicated and involve different equipment. The steel is treated by way of cold forging after step of hot forging, and the steel is then cut and milled to form the basic product with rough shape of the hand tool. The basic product is then treated by steps of heat treatment, polishing and electro-coating, all of the steps are expensive and lower its competition in the market.

Some manufacturers use Zinc to replace steel because Zinc is less expensive. However, the cost for using the Zinc to make the hand tool is still high.

Furthermore, the smaller of the size of the hand tools, the lower price they have, nevertheless, the smaller hand tools have to be made by the same steps. Besides, the smaller hand tools are easily deformed during the step of heat treatment, some of the handles of the tools may deform over 180 degrees. Extra steps are required to correct the handles and this increases the cost.

U.S. Pub. No. 2004/0177733 to Peters and U.S. Pub. No. 2004/0137445 to Arvinte respectively two tools. U.S. Pat. No. 2,662,833 to Helmuth discloses an electrostatic coating method, U.S. Pat. No. 4,513,991 to Renaud discloses a convertible design surface and method for forming the same, and U.S. Pat. No. 6,015,848 to Ikushima discloses a coating composition and method for application thereof.

The present invention intends to provide manufacturing steps for manufacturing a hand tool so as to eliminate the shortcomings mentioned above.

### SUMMARY OF THE INVENTION

The present invention relates to manufacturing steps for manufacturing a hand tool, and the steps comprise:
a step of preparing a base part: a base part made by hard material being prepared and having a handle end and a head end;
a step of molding: placing the base part in a molding device and coating plastic to the whole base part by way of plastic injection molding to form the base part into a semi-product which has a handle portion and a head portion, the handle portion located corresponding to the handle end, the head portion located corresponding to the head end, an installation hole defined through the head portion;
a step of coating: electro-coating a material on outer surface of the plastic of the semi-product, and
a step of assembly: assembling a ratchet driving unit in the installation hole, the ratchet driving unit being positioned in the installation hole by using fixing members so as to obtain a final product.

The primary object of the present invention is to provide manufacturing steps for manufacturing a hand tool, the steps does not need steps of sintering, powder metallurgy, heat treatment and hot forging so as to save the manufacturing cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the present invention;

FIG. 2 is a perspective view to show the base part in the step of preparing a base part of the present invention;

FIG. 3 is a perspective view to show the base part is to be coated before the step of molding;

FIG. 4 is a perspective view to show the whole base part is coated with plastic after the step of molding;

FIG. 5 is an exploded view to show the semi-product and the ratchet driving unit and the fixing members;

FIG. 6 is a perspective view to show the final product of the present invention, and

FIG. 7 is a cross sectional view, taken along line VII-VII in FIG. 6.

### DETAILED DESCRIPTION OF THE PREFERRED EMBODIMENT

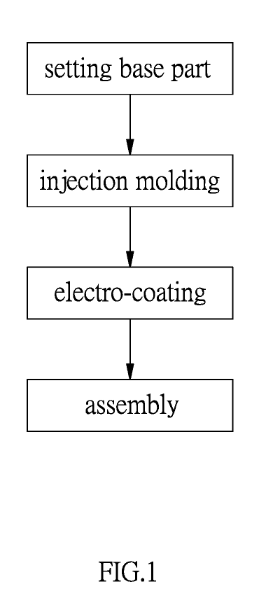

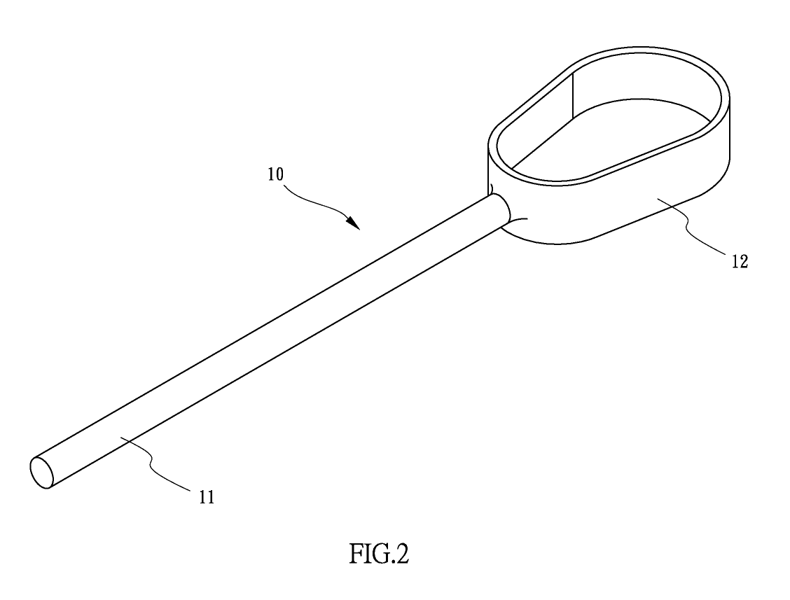

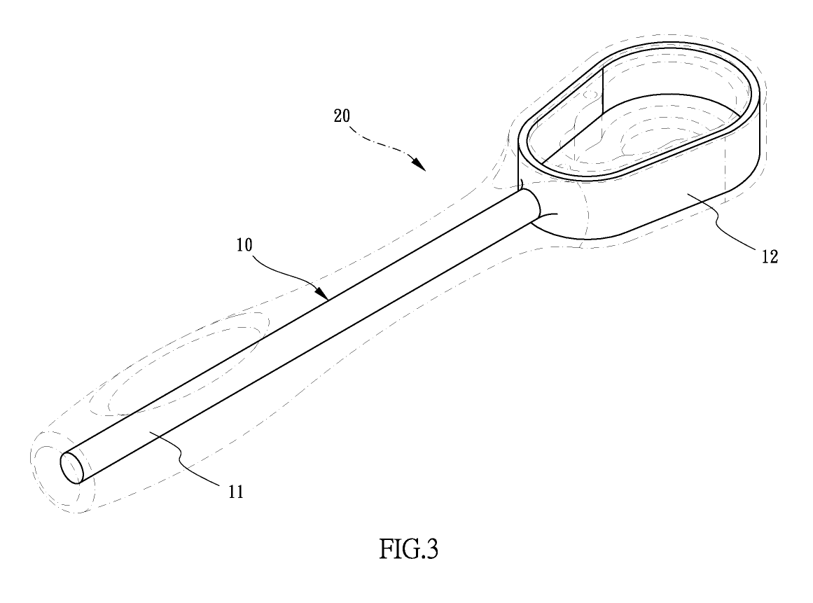

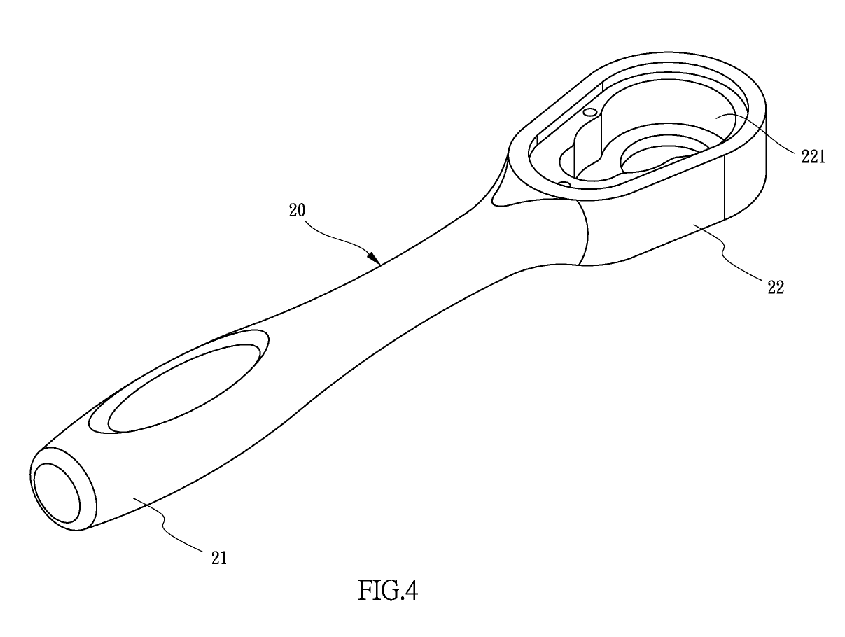

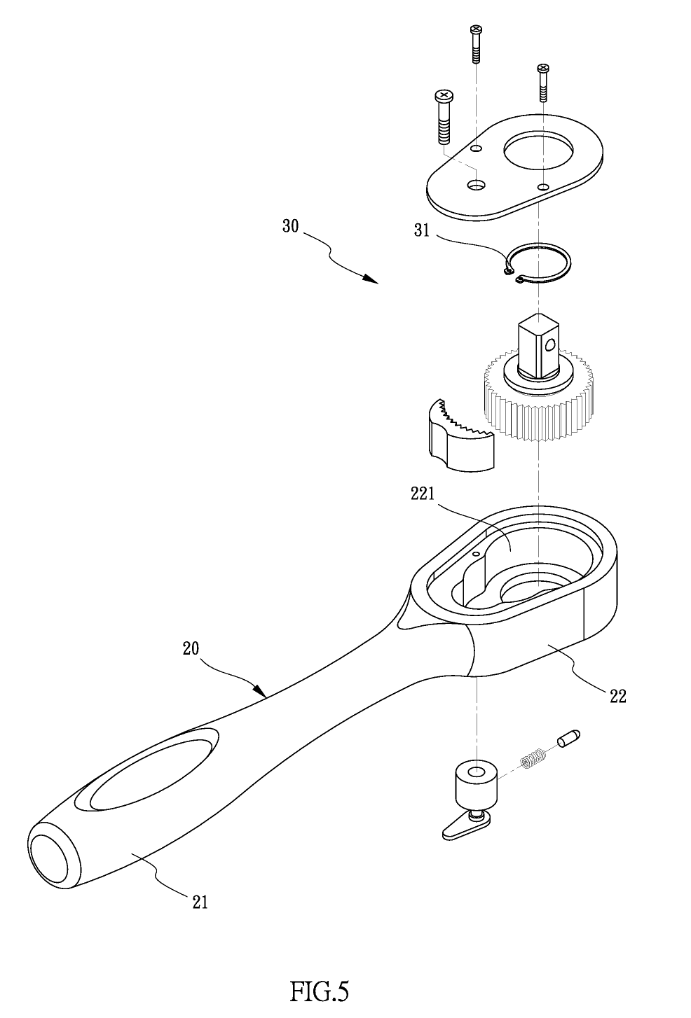

Referring to FIGS. 1 to 5, the Manufacturing steps for manufacturing a hand tool, comprising:
a step of preparing a base part: a base part 10 made by hard material being prepared and having a handle end 11 and a head end 12;
a step of molding: placing the base part 10 in a molding device and coating plastic to the whole base part 10 by way of plastic injection molding to form the base part 10 into a semi-product 20 which has a handle portion 21 and a head portion 22, the handle portion 21 located corresponding to the handle end 11, the head portion 22 located corresponding to the head end 12, an installation hole 221 defined through the head portion 22;
a step of coating: electro-coating a material on outer surface of the plastic of the semi-product 20, and
a step of assembly: assembling a ratchet driving unit 30 in the installation hole 221, the ratchet driving unit 30 being positioned in the installation hole 221 by using fixing members 31 so as to obtain a final product 40.

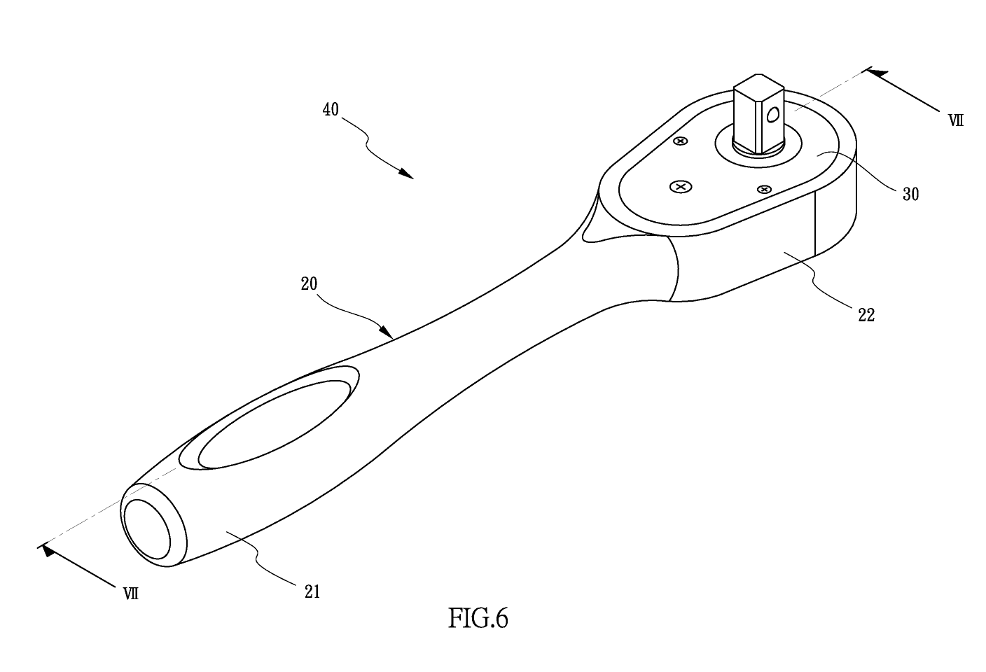

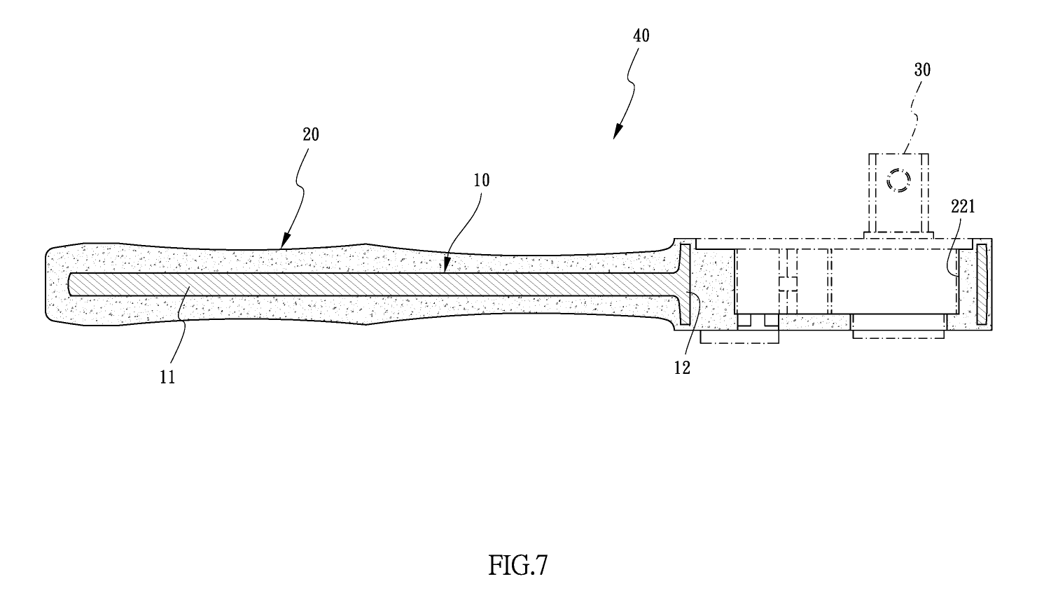

The base part 10 is made by hard material so as to have better strength, and the plastic is coated on the whole base part 10 to provide better grip feature. As shown in FIGS. 6 and 7, the plastic is coated to the outer surface of the whole base part 10 and includes the inner surface of the installation hole 221.

The ratchet driving unit 30 is also made by hard material and includes a ratchet wheel, a pawl engaged with the ratchet wheel, a bead, a biasing spring which biases the bead to the pawl, and a selection member which shifts the bead to control the movement of the pawl so as to control the rotational direction of the ratchet wheel to output torque.

The step of coating coats plastic to whole base part 10 and the plastic is coated to the outer surface of the whole base part 10 including the inner surface of the installation hole 221. Therefore, the method for making the tool is simplified when compared with the conventional methods. The simplified steps of the present invention allow the manufacturing cost of the final products 40 to be reduced about 25%-40%. The present invention has no sintering, powder metallurgy, heat treatment and hot forging required so as to save the manufacturing cost.

While we have shown and described the embodiment in accordance with the present invention, it should be clear to those skilled in the art that further embodiments may be made without departing from the scope of the present invention.

What is claimed is:

1. Manufacturing steps for manufacturing a hand tool, comprising:
a step of preparing a base part: a base part made by hard material being prepared and having a handle end and a head end;
a step of molding: placing the base part in a molding device and coating plastic to the whole base part by way of plastic injection molding to form the base part into a semi-product which has a handle portion and a head portion, the handle portion located corresponding to the handle end, the head portion located corresponding to the head end, an installation hole defined through the head portion;
a step of coating: electro-coating a material on outer surface of the plastic of the semi-product, and a step of assembly: assembling a ratchet driving unit in the installation hole, the ratchet driving unit being positioned in the installation hole by using fixing members so as to obtain a final product.
